(19) United States
(12) Patent Application Publication
(10) Pub. No.: US 2015/0239098 A1
(43) Pub. Date: Aug. 27, 2015

(54) Scaffold Workstation Tool

(71) Applicant: Kenneth Blaine Vincent, Fairmont, WV (US)

(72) Inventor: Kenneth Blaine Vincent, Fairmont, WV (US)

(21) Appl. No.: 14/514,530

(22) Filed: Oct. 15, 2014

Related U.S. Application Data
(60) Provisional application No. 61/945,518, filed on Feb. 27, 2014.

(51) Int. Cl. B25B 1/10; E04G 7/00

(52) U.S. Cl. CPC B25B 1/10; E04G 7/00

(57) ABSTRACT

A scaffold workstation tool is provided that provides hands-free support of a work piece from a vertical member of a scaffolding tower. The tool comprises a vice tool that can clamp a work piece between a support surface and a movable jaw, whereby the vice is supported by an elongated member terminating at an attachment end. The attachment end is adapted to secure to a vertical member of a scaffold tower, which is a vertical post generally having a rounded profile. Two embodiments of the attachment end are contemplated: a cup-lock attachment and a clamp attachment. Both embodiments support the tool in a horizontal condition such that work pieces can be supported by the vise for the user to operate thereon without using hands to support the same.

### CROSS REFERENCE TO RELATED APPLICATION

This application claims the benefit of U.S. Provisional Application No. 61/945,518 filed on Feb. 27, 2014. The above identified patent application is herein incorporated by reference in its entirety to provide continuity of disclosure.

### BACKGROUND OF THE INVENTION

1. Field of the Invention

The present invention relates to scaffolding devices and work stations. More specifically, the present invention relates to a vise tool that can support work pieces for a user and attach to a scaffolding assembly for stable use.

Many construction projects involve the erection of scaffolding to support workers and equipment in an elevated position adjacent to a structure. Many activities can be conducted while supported by scaffolding, including constructing primary structure, applying finishing materials and façades to a building, installing windows, and installing piping or wiring. Workers traverse the scaffolding to a desired position and engage in their work activities from the elevated state, using tools and operating on equipment to install necessary items.

Construction workers, boilermakers, electricians, and other repair professionals are often required to make several adjustments to equipment in cases where pipes or tubes need to be cut or grounded. The worker is thus often obliged to travel to the ground level in order to perform the adjustment, thus wasting time and energy. In some cases, a worker may attempt to make an adjustment using a saw in one hand and a piece of pipe or other item in the other hand. This can create a dangerous situation and a dangerous work environment in which the worker or bystanders can be injured. This method can also result in poor craftsmanship.

The ability to make adjustments to material and equipment being installed while on the scaffolding is imperative to efficiency and productivity. Cutting material or otherwise adjusting equipment to be installed can quickly become cumbersome if the operation is conducted using tools on the ground surface. The present invention contemplates a tool that can provide assistance with material handling when making such adjustments. Specifically, the present invention contemplates a vise tool that is affixable to existing scaffolding, whereby the vise provides a worker with an additional support for a work piece being cut, bent, or otherwise adjusted. This allows the worker to use both hands on the tool and not focus on supporting the work piece while in an elevated position.

More specifically, the present invention contemplates a vice tool that is adapted to clamp to a vertical member of a scaffolding assembly, and optionally secure to a specific scaffolding arrangement. A general clamp for a tubular scaffolding member is contemplated, as well as a specific connector suitable for use with “cuplock” scaffolding, as disclosed in U.S. Pat. No. 3,992,118 to Siegers. This type of scaffolding joint is commonly deployed in the field and employs an underside cup and a movable retaining element thereover that secures over several scaffolding members. The cup and the retaining element sandwich the scaffolding members between the element and the cup. It is contemplated that the present invention can be configured to be supported by a joint of this type, as well as generally from a scaffolding vertical post member.

2. Description of the Prior Art

Devices have been disclosed in the prior art that relate to tools affixable to scaffold towers. These include devices that have been patented and published in patent application publications. These devices generally relate to tools having different purposes and working elements than that of the present invention. The following is a list of devices deemed most relevant to the present disclosure, which are herein described for the purposes of highlighting and differentiating the unique aspects of the present invention, and further highlighting the drawbacks existing in the prior art.

One such device in the art related to tools affixable to scaffold towers is U.S. Patent Publication No. 2012/0055839 to Moore. Moore discloses a tool tray that secures to railings of a scaffold tower, whereby the tray includes an open area and upstanding lips to support tools and supplies. The Moore device, while securing to a scaffolding tower, is adapted to secure to one or more horizontal scaffold members, and moreover provide a function significantly divergent from that of the present invention.

Similar to Moore is U.S. Patent Publication No. 2006/0169537 to Enochs, which comprises a tool basket that is configured to engage upstanding scaffolding members. Sockets disposed within the basket accept therein the upper portion of a scaffolding member to secure the same to a scaffolding tower. As with Moore, the Enochs device is adapted to provide a tray or tool storage area, as opposed to a vice affixable to a scaffolding assembly.

Another tool affixable to a scaffolding tower is U.S. Pat. No. 2,245,661 to Fieroh, which discloses a safety system for a ladder placed against the scaffolding tower. The device comprises a hook that secures a rung of an inclined ladder to the scaffolding. The device prevents the inclined ladder from moving once positioned against the scaffolding tower, preventing instability or movement thereof. Similar to the Moore and Enochs devices, the Fieroh device is a tool affixable to a scaffolding tower with diverging elements and purposes.

While the device of the prior art include those that are affixable to a scaffolding tower, no devices are present for securing a vice to a scaffold and providing a workstation upon which a work piece can be supported without requiring the hands of the user. The tools of the prior art represent those having different purposes and structures. The present invention contemplates vice tool that is securable to a vertical member of a scaffolding tower, whereby the vice is statically supported and can be used as an “extra pair of hands” while a user manipulates or operates on a supported work piece.

Overall, it is submitted that the present invention substantially diverges in design elements from the prior art, and consequently it is clear that there is a need in the art for an improvement to existing scaffold workstation devices. In this regard the instant invention substantially fulfills these needs.

### SUMMARY OF THE INVENTION

In view of the foregoing disadvantages inherent in the known types of tools affixable to scaffolding towers now present in the prior art, the present invention provides a new vice tool that can be utilized for providing convenience for the user when working on a scaffolding tower and supporting a work piece with a tool that attaches to the vertical portion of a scaffold.

It is therefore an object of the present invention to provide a new and improved scaffold workstation tool that has all of the advantages of the prior art and none of the disadvantages.

It is another object of the present invention to provide a scaffold workstation tool that is affixable to a vertical member of a scaffolding tower, providing a static and independently supported vice tool for a user to work on an article held by the vice.

Another object of the present invention is to provide a scaffold workstation tool that affixes to a vertical member of a scaffolding tower using one or more contemplated attachment methods, whereby an independent clamp is utilized, or a more specific cup scaffolding support is employed to support the vice in a static condition from the scaffolding.

Yet another object of the present invention is to provide a scaffold workstation tool that can support a work piece as a user engages the work piece with another tool and while using two hands to work on the work piece or hold another tool.

Another object of the present invention is to provide a scaffold workstation tool that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of the scaffold workstation tool of the present invention.

FIG. 2 shows another view of the scaffold workstation tool of the present invention and one contemplated attachment end thereof.

FIG. 3 shows a view of the scaffold workstation tool being secured to a cup-lock scaffold assembly.

FIG. 4 shows an overhead view of the clamp embodiment of the scaffold workstation tool attachment end.

### DETAILED DESCRIPTION OF THE INVENTION

Reference is made herein to the attached drawings. Like reference numerals are used throughout the drawings to depict like or similar elements of the scaffold workstation tool of the present invention. For the purposes of presenting a brief and clear description of the present invention, the preferred embodiment will be discussed as used for providing hands-free support of a work piece from a scaffold tower vertical member. The figures are intended for representative purposes only and should not be considered to be limiting in any respect.

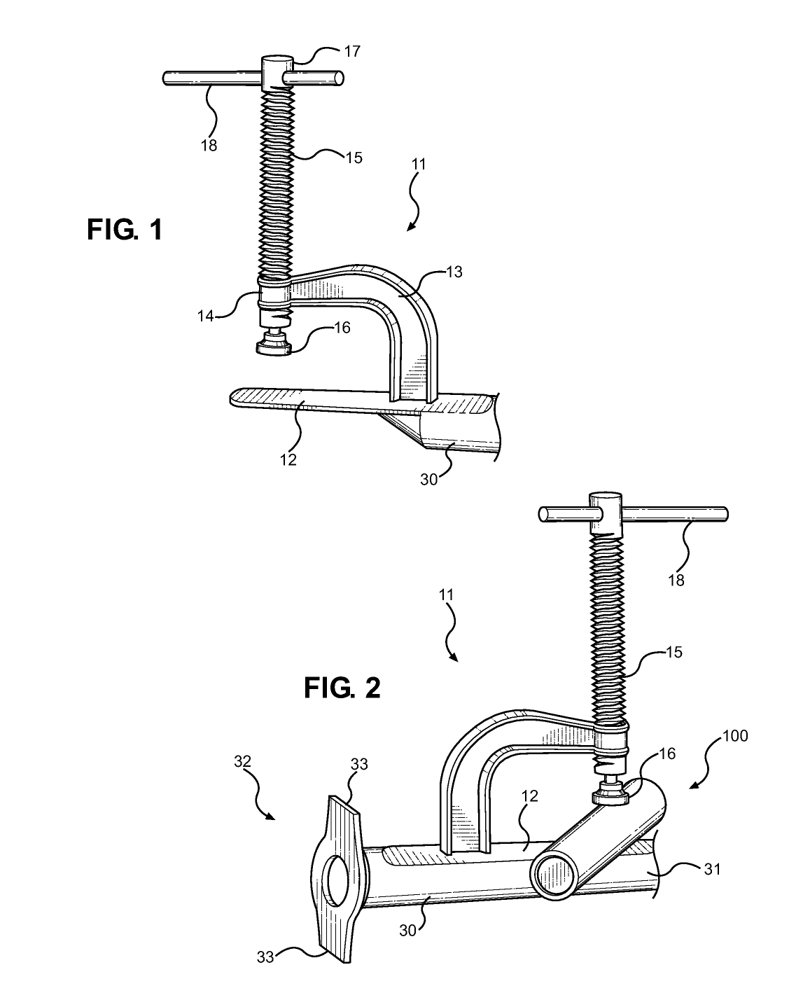

Referring now to FIG. 1, there is shown a side view of the scaffold workstation tool of the present invention. The tool provides a hands-free support for a user to place a work piece in the tool and operate on the work piece without physically supporting the work piece at the same time. The tool is affixed to a vertical member of a scaffolding tower, thus providing an additional support for a user while in an elevated position and where otherwise a vice tool would not be available.

The tool comprises a vice having a substantially horizontal and elongated support surface 12 upon which to support a work piece. Above the support surface 12 is a vice assembly 11 that supports a moveable jaw 16 using an arm member 13 and a threaded rod 16. The support surface 12 comprises an elongated and potentially widened area upon which to place a work piece. To clamp the work piece to the support surface 12, the user employs the vice assembly 11, thereby clamping the work piece as the assembly is supported from a scaffold upstanding member.

Attaching to and extending from the support surface 12 is an elongated member 30. The elongated member extends from the support surface 12 and terminates at an attachment end. The attachment end is adapted to clamp to or be temporarily affixed to a vertical post of a scaffold tower. Once the attachment end is affixed to the scaffold tower, the user can clamp a work piece using the vice assembly 11 and handle other tools to operate on the work piece as needed.

The vice assembly 11 includes an L-shaped, upstanding arm member 13 that extends upwards and over the support surface 12. The lower end of the upstanding arm member secures to the support surface 12 and the upper end 14 thereof terminates above the support surface 12. The upper end 14 comprises a threaded aperture through which the threaded rod 15 of the vice can be rotated through. As is known in the art of vices, the threaded rod 15 includes a lower end that terminates in a clamping jaw 16, while the upper end 17 of the threaded rod 15 includes an outwardly extending handle portion 18. Rotation of the rod 15 adjusts the separation between the jaw 16 and the support surface 12, and thus the clamping pressure applied to a work piece therebetween.

Referring now to FIG. 2, there is shown a view of the workstation tool of the present invention supporting a work piece 100. Also shown is a view of one contemplated embodiment of the attachment end 32 of the present invention. In this embodiment, the attachment end comprises a base having a pair or more outwardly extending tabs 32. The base is adapted to be pressed against a rounded scaffold member, while the tabs 32 are adapted to be secured against the upstanding scaffold member using a cup-lock attachment method. This method supports the tabs 32 and retains the base of the attachment end 32 against the upstanding scaffold member, allowing the elongated member 30 of the tool to be extended outward therefrom in a substantially horizontal condition.

The elongated member 30 is comprised of the attachment end 32 at one end, and a distal end 31 at a second end. Above the elongated member 30 is the support surface 12, over which the vice assembly 11 is located. Between the vice assembly 11 and the support surface 12, a work piece 100 is clamped and statically supported as a user engages the work piece 100 (i.e. modifying the article, trimming, etc. with another tool). The work piece 100 is clamped by the vertically movable jaw member 16 of the vice, controlled by the threaded rod 15 and the user handle 18.

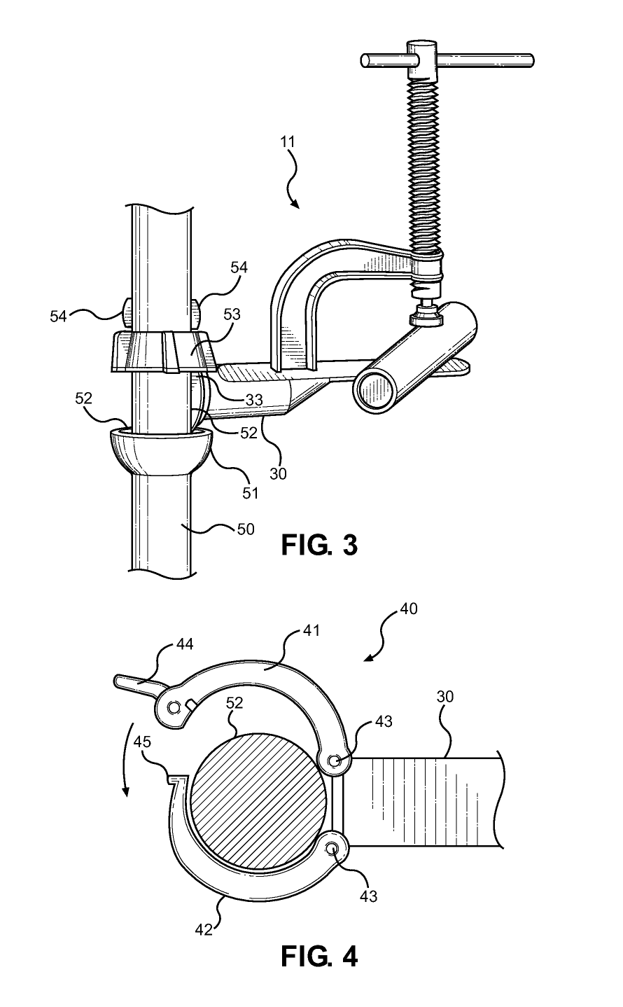

Referring now to FIG. 3, the cup-lock attachment scheme of the present tool is highlighted. Using a cup-lock attachment method, the tool is supported by the scaffolding structure and employs the same method of construction to affix the attachment end of the tool. The cup-lock attachment is one in which the vertical and horizontal members 50 of the scaffold tower are attached to one another using a cup 51 and a locking ring 53. The cup 51 is a rounded member having a flat upper area and an open volume 51 within which to accept the tabs of a horizontal scaffold member. However, the cup 51 is used in this instance to support the lower tab 33 of the attachment end of the tool elongated member 30.

To secure the attachment end, the lower tab 33 is placed within the cup interior 52, and the upper tab 33 is secured using the locking ring 53. The locking ring 51 slides along the vertical scaffolding member 52 and is forced over the upper tab of the tool. The locking ring surrounds the tab and retains it against the scaffolding member 52, while the cup 51 secures the lower end. The cup 51 prevents downward sliding, while the locking ring 53 reacts prying loads from the tool. Together, they secure the attachment end of the tool against the outer surface of the scaffold member 52 above the cup 51. A pair of locking ring tabs 51 along the scaffold upstanding member 52 prevents the locking ring 53 from moving upwards, thereby locking the ring around the tool tabs and preventing separation thereof.

Referring now to FIG. 4, there is shown an overhead view of an alternative attachment device disposed along the attachment end of the tool. In this embodiment, a locking clamp 40 is employed, whereby the clamp 40 surrounds and compresses the upstanding member 52 of the scaffolding. The clamp 40 includes a first hinged arm 41 and a second hinged arm 42, wherebetween a latch is used to secure the arms together. The arms 41, 42 are arcuate members secured to the attachment end of the elongated member 30 via pin joints 43. The arms secure around the scaffolding upstanding member 52 and the distal ends of the arms secure together using a tab 45 and latch arm 44. The tab 45 engages a keep in the opposite arm, whereafter the latch arm 44 draws the tab 45 towards the opposite arm and draws the arms together. This embodiment provides an attachment for the tool that does not require a specific type of scaffolding to employ the tool. It is contemplated that any clamp know to those skilled in the art may be deployed at this end, falling within the scope of securing to the scaffold upstanding member and supporting the tool in a substantially horizontal state.

Overall, the present invention provides welders, electricians, construction workers and the like with an area in which they can perform repairs and adjustments while remaining on a scaffolding structure. The invention allows individuals to perform duties without having to climb up and down scaffolding. The device minimizes the risks associated with construction workers performing dangerous work using their hands without an adequate work space and reduces the occurrence of one dropping heavy and dangerous materials. And moreover, the present invention helps to preserve time and energy by providing immediate access to necessary items.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A scaffold workstation tool, comprising:
an elongated member having an attachment end and a distal end;
a support surface along an upper surface of said elongated member;
a vice assembly comprising an L-shaped, upstanding arm member extending upwards and over said support surface;
said arm member having an upper end comprising a threaded aperture;
said threaded aperture threadably connected to an elongated, threaded rod;
said threaded aperture supporting said threaded rod substantially perpendicularly to said support surface;
said threaded rod having an lower end comprising a vice jaw, and an upper end comprising a user handle, whereby rotation of said threaded rod adjusts a gap between said vice jaw and said support surface;
said attachment end further comprising a base having a pair or more flared tabs extending therefrom;
said tabs configured to vertical scaffold member via a cup-lock scaffolding attachment.

2) A scaffold workstation tool, comprising:
an elongated member having an attachment end and a distal end;
a support surface along an upper surface of said elongated member;
a vice assembly comprising an L-shaped, upstanding arm member extending upwards and over said support surface;
said arm member having an upper end comprising a threaded aperture;
said threaded aperture threadably connected to an elongated, threaded rod;
said threaded aperture supporting said threaded rod substantially perpendicularly to said support surface;
said threaded rod having an lower end comprising a vice jaw, and an upper end comprising a user handle, whereby rotation of said threaded rod adjusts a gap between said vice jaw and said support surface;
said attachment end further comprising an attachment clamp that includes a first arm and a second arm configured to secure together about a vertical scaffold member.
